(19) United States
(12) Patent Application Publication
(10) Pub. No.: US 2011/0129089 A1
(43) Pub. Date: Jun. 2, 2011

(54) METHOD AND APPARATUS FOR PARTIALLY ENCODING/DECODING DATA FOR COMMITMENT SERVICE AND METHOD OF USING ENCODED DATA

(75) Inventors: Seung-Hyun KIM, Daejeon (KR); Jong-Hyouk NOH, Daejeon (KR); Deok-Jin KIM, Daejeon (KR); Soo-Hyung KIM, Daejeon (KR); Sang-Rae CHO, Daejeon (KR); Young-Seob CHO, Daejeon (KR); Jin-Man CHO, Daejeon (KR); Dae-Seon CHOI, Daejeon (KR); Seung-Hun JIN, Daejeon (KR)

(73) Assignee: Electronics and Telecommunications Research Institute, Daejeon-city (KR)

(21) Appl. No.: 12/939,665

(22) Filed: Nov. 4, 2010

(30) Foreign Application Priority Data
Nov. 30, 2009 (KR) 10-2009-0117329

(51) Int. Cl. H04L 9/08; G06F 17/00

(52) U.S. Cl. 380/284; 715/236

(57) ABSTRACT

Disclosed herein is a method and apparatus for partially encoding/decoding data for a commitment service and a method of using encoded data. The apparatus includes an encoding/decoding module for encoding/decoding a database to be committed to a server using a private key of the user, obtained by accessing a key storage unit through a key management module which manages information about the private key of the user, stored in the key storage unit, and also encoding/decoding an SQL query required to use a DB committed to the server. The encoding/decoding module partially encodes/decodes one or more of table names, field names, and attribute values of the DB. In the present invention, the table names, field names, and field attribute values of the DB are partially encoded while the existing structure of the DB is maintained, and the partially encoded DB is committed to the server.

### CROSS REFERENCE TO RELATED APPLICATION

This application claims the benefit of Korean Patent Application No. 10-2009-0117329, filed on Nov. 30, 2009, entitled “Method and apparatus for encoding/decoding partial of data and method for using the data,” which is hereby incorporated by reference in its entirety into this application.

### BACKGROUND OF THE INVENTION

1. Technical Field

The present invention relates generally to a method and apparatus for partially encoding/decoding data for a commitment service and a method of using encoded data and, more particularly, to a method and apparatus for partially encoding/decoding data for a commitment service and a method of using encoded data, which partially encode a database (DB), commit the partially encoded DB to a server, and also partially encode a query required to use the DB, thus providing a security-enhanced DB commitment service.

2. Description of the Related Art

All service providers which provide online services have their own databases (DBs) in which information about users is stored. However, since typical DBs store information in the form of cleartext (or plaintext), there frequently occur cases in which user information is misused due to hacking or malicious insiders. In order to overcome these cases, various methods of encoding DBs have been presented. However, since most DB encoding methods are processed by a server, a problem arises in that the DBs are easily decoded when information about the server is leaked.

In the related art, a conventional encoding/decoding method has been presented and is configured such that when a representative keyword is input, a related document is encoded using a document encoding key, the representative keyword is encoded as a search key, and the search key is created as an index, and such that when an authenticated user enters a keyword, searching is performed by encoding the keyword as a search key, and the results of the searching are returned and are decoded using the document encoding key. However, such a method is inconvenient in that even after a keyword is input and encoded, searching must be performed, and thus the inaccurate results of the searching may be obtained, and encoding/decoding must be performed on a document basis.

Meanwhile, as methods in which a security management module combined with a DB encodes the DB and controls access to the DB, there have been presented methods of performing encoding/decoding on a column basis in such a way that a manager assigns authority for encoding/decoding to each user and permits users having passed an access control procedure to use encoding/decoding. However, in such a method, there is a probability that all of data may be leaked when it is hacked because all encoding/decoding information is included in the DB. Further, since the same encoding/decoding key rather than different encoding/decoding keys is used for different users, such a method is suitable only for DBs for public use, which store business data.

Further, there have been provided methods in which when a query is transmitted, the system recognizes the user's making access and then returns the user's specific value, and in which when the user requests encoding/decoding using the specific value, the system returns the results of encoding and stores/loads the results of the encoding in/from the DB. However, in such a method, a DB management system stores all security information and performs encoding/decoding. Accordingly, when the system is leaked, all of the contents stored in the DB may be misused. Further, since security is not applied to queries, information requested by the user and received contents may be predicted.

### SUMMARY OF THE INVENTION

Accordingly, the present invention has been made keeping in mind the above problems occurring in the prior art, and an object of the present invention is to provide a security-enhanced DB commitment service by partially encoding table names, field names and field attribute values of a DB while maintaining the existing structure of the DB, and by committing the partially encoded DB to a server.

Another object of the present invention is to provide a security-enhanced service even at the time of using a commitment service by encoding part of a query and requesting a user's DB using the partially encoded query from a server when a client accesses the user's DB that has been committed to the server.

In order to accomplish the above objects, the present invention provides a method for partially encoding data for a commitment service, including, when a private key is input by a user, transforming the private key, encoding table names of a database (DB) to be committed to a server using the private key and also encoding field names of each table and fields stored in the table, transmitting the DB through a trusted channel established between a user terminal and the server to request commitment of the DB to the server, and deleting the DB committed to the server from the user terminal according to a response signal from the server.

Preferably, the encoding may include adding a random character string to an attribute value stored in each field of the table, and the attribute value to which the character string is added is encoded.

Preferably, the method may further include, before the encoding, copying the DB to be committed to the server to a predetermined area so as to encode the DB.

Preferably, the deleting may include deleting the DB copied to the predetermined area.

Preferably, the method may further include, before the requesting the commitment of the DB, establishing the trusted channel between the user terminal and the server based on authentication information shared therebetween.

Preferably, the transforming the private key may be performed using a random permutation function.

Further, in order to accomplish the above objects, the present invention provides a method for partially decoding data for a commitment service, including a user terminal requesting a database (DB) of a user stored in a server to receive the DB from the server, transforming a private key input by the user so as to decode the DB received from the server, decoding table names of the received DB using the private key and also decoding field names and fields of each table, and requesting the server to delete the DB stored in the server.

Preferably, the method may further include copying the DB at the receiving to a temporary area for decoding, and after the decoding, storing the DB copied to the temporary area, at a designated location.

Preferably, the transforming the private key may be performed using a random permutation function.

Furthermore, in order to accomplish the above objects, the present invention provides a method of using encoded data, including when an application program is executed, generating a Structured Query Language (SQL) query required to perform tasks based on a database (DB) committed to a server, loading a previously registered private key of a user to encode the SQL query using the private key, transmitting an encoded SQL query to the server, and receiving an execution result message of the SQL query, generated after execution of the SQL query, from the server, and decoding the execution result message of the SQL query to apply a decoded execution result message of the SQL query to the application program.

Preferably, the execution result message of the SQL query may be configured in an Extensible Markup Language (XML) format by the server.

Preferably, the encoding the SQL query encodes at least one of field names, table names, and attribute values of the SQL query, using the private key of the user.

Preferably, the encoding the SQL query encodes the SQL query such that grammar of the SQL query is maintained without change.

Preferably, the applying the decoded execution result message of the SQL query to the application program may further include generating a data type, which is usable by the application program, using the decoded execution result message of the SQL query, and wherein the application program is executed using the data type.

Furthermore, in order to accomplish the above objects, the present invention provides an apparatus for partially encoding/decoding data for a commitment service, including a key storage unit for storing a private key of a user, a key management module for, when the private key is input by the user, transforming the private key to store a transformed private key in the key storage unit, and managing information about the private key, and an encoding/decoding module for encoding/decoding a database (DB) to be committed to a server using the private key of the user, which has been obtained by accessing the key storage unit through the key management module, and also encoding/decoding a Structured Query Language (SQL) query required to use the DB committed to the server, wherein the encoding/decoding module partially encodes/decodes at least one of table names, field names, and attribute values of the DB.

Preferably, the encoding/decoding module may perform encoding by adding a random character string to a relevant attribute value of the DB when the DB is encoded.

Preferably, the key management module may generate a transformed private key of the user whenever a new DB is committed to the server.

Preferably, the key management module may be configured such that when a predetermined period of time has elapsed or when a specific condition is satisfied, with respect to the private key of the user stored in the key storage unit, the private key of the user is deleted.

Preferably, the key management module may use a random permutation function when the private key of the user is transformed.

Preferably, the apparatus may further include an application execution module for generating the SQL query that allows the application program to perform DB-based tasks and executing the application program using an execution result message of the SQL query received from the server in response to the SQL query.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram showing the construction of an apparatus for partially encoding/decoding data for a commitment service according to the present invention;

FIG. 2 is a flowchart showing the operation of a method of partially encoding data for a commitment service according to the present invention;

FIG. 3 is a flowchart showing the operation of a method of partially decoding data for a commitment service according to the present invention; and

FIG. 4 is a flowchart showing the operation of a method of using encoded data according to the present invention.

### DESCRIPTION OF THE PREFERRED EMBODIMENTS

If in the specification, detailed descriptions of well-known functions or configurations may unnecessarily make the gist of the present invention obscure, the detailed descriptions will be omitted.

The terms and words used in the present specification and the accompanying claims should not be limitedly interpreted as having their common meanings or those found in dictionaries, but should be interpreted as having meanings adapted to the technical spirit of the present invention on the basis of the principle that an inventor can appropriately define the concepts of terms in order to best describe his or her invention.

It should be noted that the same reference numerals are used throughout the different drawings to designate the same or similar components as much as possible.

Hereinafter, embodiments of the present invention will be described in detail with reference to the attached drawings.

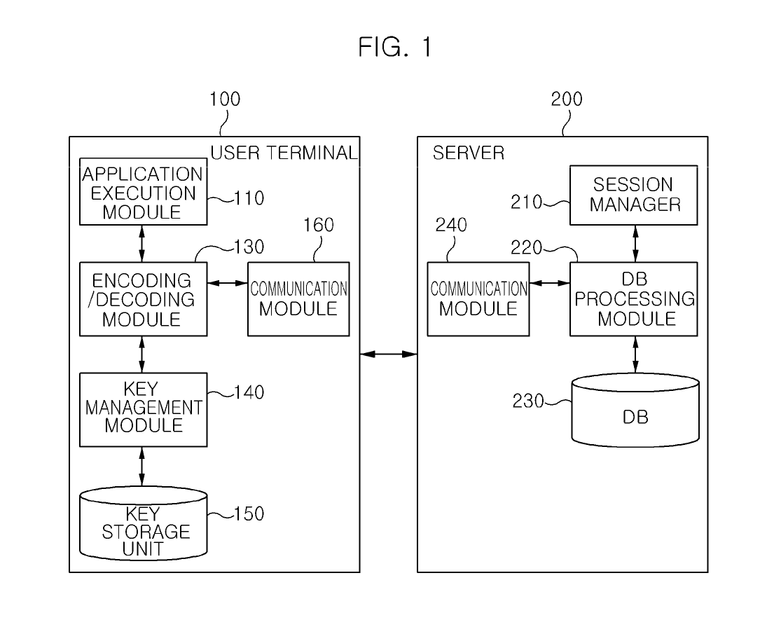

FIG. 1 is a diagram showing the construction of an apparatus for encoding/decoding data according to the present invention, which illustrates a block diagram to be referred to when describing the construction of the data encoding/decoding apparatus according to the present invention.

Referring to FIG. 1, a system applied to the present invention includes a user terminal 100 and a server 200.

First, in the data encoding/decoding apparatus according to the present invention, the user terminal 100 includes an application execution module 110, an encoding/decoding module 130, a key management module 140, a key storage unit 150, and a communication module 160.

The application execution module 110 is a module for executing application programs on the user terminal 100. In this case, the application programs executed by the application execution module 110 are run using a database (DB).

The encoding/decoding module 130 is a module for processing the encoding and decoding of Structured Query Language (SQL) queries using the private key of the user.

Here, the encoding/decoding module 130 encodes the field names, table names, attribute values, etc. of each SQL query, generated during the execution of an application program, using the private key of the user. However, the encoding/decoding module 130 maintains the grammar of the SQL query without change when the SQL query is encoded.

The following embodiment illustrates an example in which the encoding/decoding module 130 encodes an SQL query.

```
    SQL query: select name, address, phone from user where id=1234
    encoding: name -> Eₖ(name) = skdfskei
        address -> Eₖ(address) = 3klsdfkjs
        phone -> Eₖ(phone) = dkfeitkj
        user -> Eₖ(user) = hrbkvkew
        id -> Eₖ(id) = ntrkkwell
        1234 -> Eₖ(1234) = wlejoflkas
    encoded SQL query: select skdfskei, 3klsdfkjs, dkfeitkj from
hrbkvkew where ntrkkwell=wlejoflkas
```

In other words, when an SQL query is “select name, address, phone from user where id=123”, field names ‘name’, ‘address’, and ‘phone’, table names ‘user’ and ‘id’, and the attribute value ‘1234’ are individually encoded.

In this case, the grammar of ‘select name’ and ‘phone from user where id=1234’ is maintained without change, and thus the encoded SQL query is “select skdfskei, 3klsdfkjs, dkfeitkj from hrbkvkew where ntrkkwell=wlejoflkas.”

The communication module 160 is a module for transmitting the SQL query generated by the encoding/decoding module 130 to the server 200 through a trusted channel, and receiving a response from the server 200.

When security is required, the communication module 160 can encode a communication channel using security information between the user terminal 100 and the server 200, which has been previously established.

Further, the communication module 160 does not leak session information, and defends itself against typical attacks using the function of utilizing nonce information or the like.

The key management module 140 functions to store information about private keys, input by the user for a predetermined period of time, in the key storage unit 150 requiring security, and to load the private key information therefrom.

The key storage unit 150 is located in the memory of an area safe from hacking, and can be accessed only by the key management module 140. Therefore, the encoding/decoding module 130 accesses the private key of the user stored in the key storage unit 150 through the key management module 140. The private key of the user stored in the key storage unit 150 is vanished by the key management module 140 when a predetermined period of time has elapsed or when a specific condition is satisfied.

Meanwhile, the communication module 160 receives a message indicative of the results of the execution of the SQL query (hereinafter referred to as an “execution result message of the SQL query”) from the server 200 as a response corresponding to the SQL query transmitted to the server 200.

When the execution result message of the SQL query has been received through the communication module 160, the encoding/decoding module 130 accesses the private key of the user stored in the key storage unit 150 through the key management module 140.

The encoding/decoding module 130 decodes the execution result message of the SQL query using the private key of the user stored in the key storage unit 150.

In this case, the execution result message of the SQL query is converted into an Extensible Markup Language (XML) format by the DB processing module 220. Therefore, the execution result message of the SQL query, decoded by the encoding/decoding module 130, has the following structure.

```
<xml>
  <row>
    <name>Seung-Hyun Kim</name>
    <address>ABCD, Daejeon</address>
    <phone>012-345-6789</phone>
  </row>
</xml>
```

The decoded execution result message of the SQL query is either used as an input value required to automatically generate a specific data type, or used in a process for allowing the encoding/decoding module 130 to directly set the value suitable for a data type.

In this case, the application program executed by the application execution module 110 receives the data type generated using the decoded execution result message of the SQL query and performs the service supported by the application program.

Meanwhile, in the data encoding/decoding apparatus according to the present invention, the server 200 includes a session manager 210, a DB processing module 220, a DB storage unit 230, and a communication module 240.

The session manager 210 is an existing program for storing information about the Identifications (IDs) and sessions of clients in a web environment, and is configured to store the physical location, DB handler, nonce information, session key, etc. of a DB committed by each authenticated user.

The DB storage unit 230 stores the DB committed by the user terminal 100.

The communication module 240 performs the same function as the communication module 160 in the client 100, and, in detail, identifies the client 100, verifies an SQL query, and returns the results of the SQL query. The SQL query verified by the communication module 240 is transferred to the DB processing module 220.

The DB processing module 220 executes the SQL query transferred by the communication module 240 on the DB committed by the authenticated user. In this case, execution results, obtained after the execution of the SQL query, have a specific data type.

Therefore, the DB processing module 220 converts the format of the execution results of the SQL query into a universal format such as an XML format so as to transmit the execution results of the SQL query over a network and use them in heterogeneous systems.

The execution result message of the SQL query is identified by <xml> and the execution results are identified by <row>.

Here, data in <row> refers to the field names of a table and the attribute value of each relevant field. Since the field names and attribute values of the DB are encoded using the private key of the user, the data in <row> is represented by the following random character strings.

```
<xml>
  <row>
    < skdfskei>wiejfklsdf</ skdfskei>
    <3klsdfkjs>sseijofeklfskef</3klsdfkjs>
    <dkfeitkj>eilfjekjsf</dkfeitkj>
  </row>
  <row>
    ....
  </row>
</xml>
```

As described above, when one or more results are obtained, syntax <row> is added.

The communication module 240 transmits the execution result message of the SQL query, which has been converted into the XML format by the DB processing module 220, to the user terminal 100.

Thereafter, the user terminal 100 decodes the execution result message of the SQL query from the server 200 using the private key of the user stored in the key storage unit 150, as described above, and thereafter the application program performs the service using the decoded execution result message.

The operation of the present invention constructed as described above is described below.

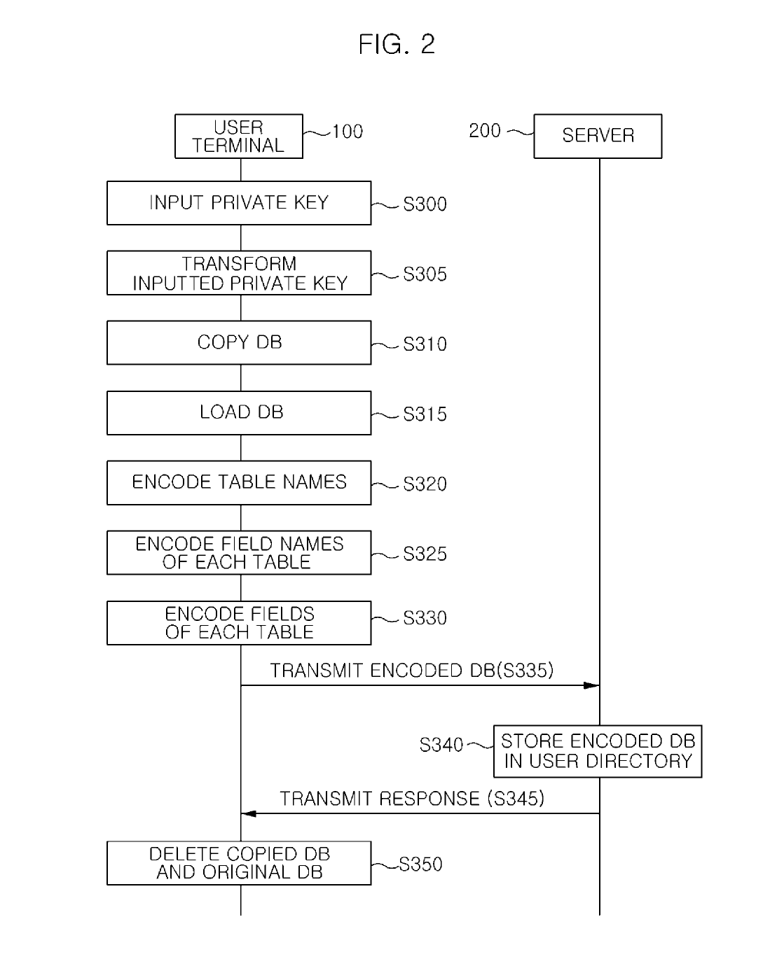

FIGS. 2 to 4 are flowcharts showing a method of operating the data encoding/decoding apparatus according to the present invention.

First, FIG. 2 illustrates an operation in which the user terminal sets an encoded DB in the server according to an embodiment of the present invention.

As shown in FIG. 2, when a private key is input to the user terminal 100 by the user at step S300, the key management module 140 transforms the private key input by the user at step S305. In this case, the key management module 140 transforms the private key of the user using a random permutation function.

Further, the key management module 140 may add specific information about the user or information about the server 200 during the transformation of the private key of the user, and generates a private key whenever a DB is committed to the server 200. Each private key of the user generated by the key management module 140 is stored in the key storage unit 150.

When the generation of the private key performed by the key management module 140 was completed, the encoding/decoding module 130 copies the DB to a predetermined area so as to encode the DB to be committed to the server 200 at step S310, and starts a procedure for encoding the DB at steps S315 to S330.

In the encoding procedure performed by the encoding/decoding module 130, the encoding/decoding module 130 loads the DB at step S315, encodes the table names of the DB using the private key of the user at step S320, and also encodes the field names of each table using the private key of the user at step S325.

Further, when the encoding of the table was completed in this way, the fields stored in the table are individually encoded using the private key of the user at step S330.

In such an encoding procedure, the attribute values of the fields of the table of the DB can be used without change, but a random character string can be added to a relevant attribute value.

Next, an example of the addition of a random character string is described.
original DB attribute value: “Seung-Hyun Kim”
random character string: “akblkaklfklskfdlawe”
combination with the character string: “Seung-Hyun Kiml akblkaklfklskfdlawe” (‘|’ is a delimiter)
results of encoding of only the attribute of the original: “skfiskjef”
results of encoding after combination with the character string: “aslkidklaslfkewlkjdfslkjfsdf”

In this case, since the encoded attribute value has a certain size, the length of the character string of the encoded attribute value is measured from the DB, thus enabling attacks that infer a specific data type to be avoided.

Thereafter, the communication module 160 transmits the DB, which has been encoded as described above, to the server 200 through the trusted channel established between the user terminal 100 and the server 200 at step S335.

In this case, the trusted channel is established based on authentication information previously shared between the user terminal 100 and the server 200.

Meanwhile, when the DB stored in the user terminal 100 has been received through the communication module 240, the DB processing module 220 of the server 200 stores the DB in a directory assigned to the authenticated user at step S340.

When the DB of the user has been successfully stored, the server 200 transmits a response to the request received from the user terminal 100 at step S345. Of course, when the storage of the user DB has failed, the server 200 transmits a response indicative of a failure.

When a response signal indicating that the user DB has been successfully stored is received from the server 200, the user terminal 100 deletes both the DB copied at step S310 and the original DB at step S350.

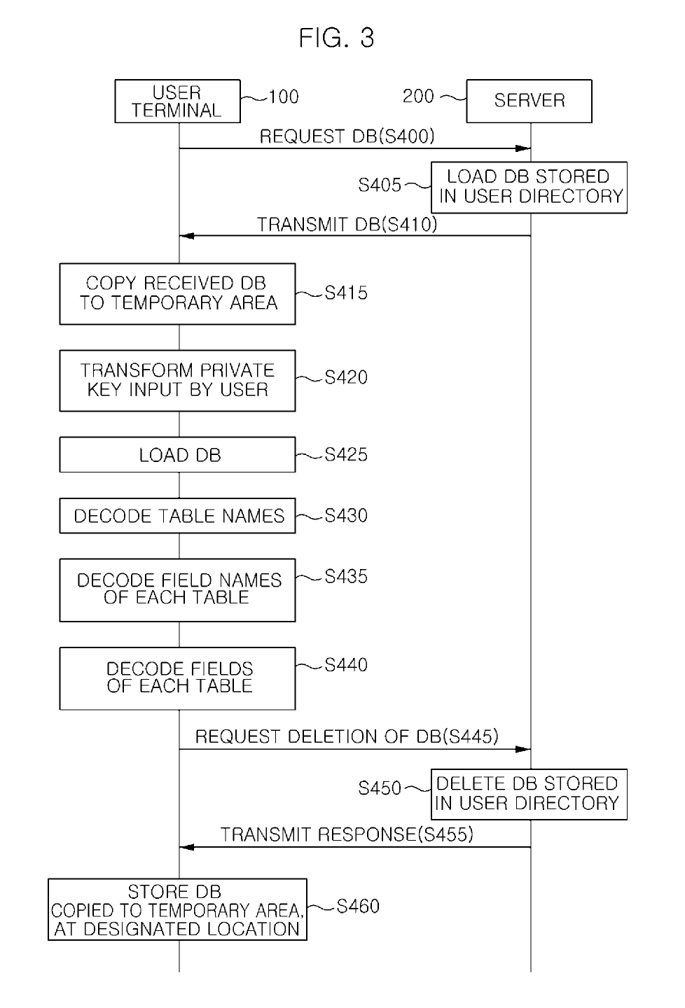

FIG. 3 illustrates an operation in which the user terminal deletes the encoded DB stored in the server according to an embodiment of the present invention.

As shown in FIG. 3, when the user terminal 100 requests the DB registered in the server 200 at step S400, the server 200 loads the DB requested by a relevant user from an authenticated user directory at step S405, and transmits the DB to the user terminal 100 through the trusted channel established between the user terminal 100 and the server 200 at step S410.

When the DB is received from the server 200, the user terminal 100 copies the DB to a temporary area at step S415.

Further, the key management module 140 of the user terminal 100 transforms the private key input by the user so as to decode the received DB at step S420. In this case, the key management module 140 transforms the private key of the user using a random permutation function, similarly to step S305 of FIG. 2. Here, the transformed private key of the user is stored in the key storage unit 150.

Thereafter, the encoding/decoding module 130 performs a procedure for decoding the DB at step S425 to S440.

In the decoding procedure, the encoding/decoding module 130 loads the DB, which has been copied at step S415, at step S425, and decodes the table names of the DB using the private key of the user that was transformed at step S420, at S430.

Further, the encoding/decoding module 130 decodes the field names of each table using the private key of the user at step S435, and thereafter decodes the fields of the table at step S440.

When the procedure for decoding the DB has been completed at steps S425 to S440, the user terminal 100 requests the server 200 to delete the DB at step S445.

The server 200 deletes the DB stored in the user directory at the request of the user terminal 100 at step S450, and transmits a response signal to the user terminal 100 at step S455.

Thereafter, the user terminal 100 having received the response signal from the server 200 stores the DB, copied to the temporary area, at a designated location at step S460.

If a response signal indicating that the deletion of the DB has failed is received from the server 200, the user terminal outputs the response signal to notify the user of the failure.

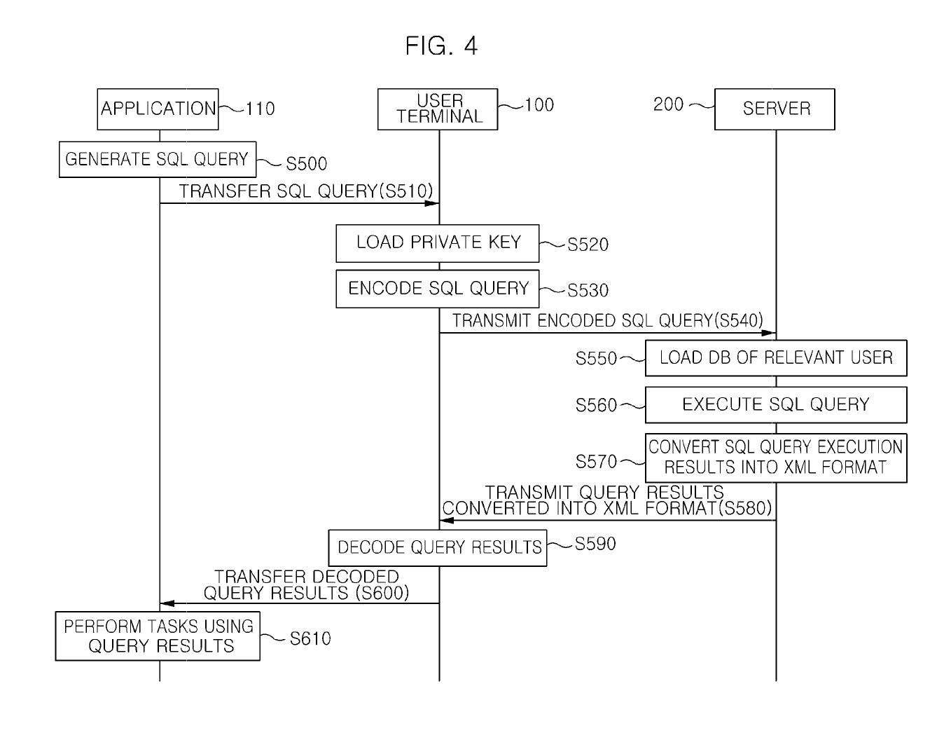

FIG. 4 illustrates an operation of calling the encoded DB stored in the server and using the encoded DB for a service according to an embodiment of the present invention.

As shown in FIG. 4, the application execution module 110 of the user terminal 100 executes an application program. In this case, since the executed application program is run using the DB, the relevant application program generates an SQL query so as to perform DB-based tasks at step S500. The SQL query generated by the application program is stated as cleartext.

Meanwhile, the application program transfers the SQL query generated at step S500 to the user terminal 100 at step S510. The encoding/decoding module 130 of the user terminal 100 accesses the key storage unit 150 through the key management module 140, loads the private key input by the user at step S520, and encodes the SQL query using the private key of the user at step S530.

In the encoding procedure of the SQL query, the encoding/decoding module 130 encodes the SQL query, except for the grammar of the SQL query, rather than the entire SQL query.

Thereafter, the user terminal 100 transmits the encoded SQL query to the server 200 through the trusted channel at step S540.

When the SQL query is received from the user terminal 100, the server 200 loads the DB from the directory of the user at step S550, and then executes the SQL query at step S560.

In this case, the DB processing module 220 of the server 200 converts the execution results of the SQL query into an XML format at step S570, and transmits the XML format execution results of the SQL query to the user terminal 100 at step S580.

The encoding/decoding module 130 of the user terminal 100 having received the execution results of the SQL query from the server 200 decodes the received execution results of the SQL query using the private key of the user at step S590, and transfers the decoded execution results to the application program at step S600. In this case, the decoded execution results are transferred after being converted into a data type that is usable by the application program.

Therefore, the application program performs tasks using the execution results of the SQL query, decoded by the encoding/decoding module 130 of the user terminal 100, at step S610.

The embodiment of FIG. 4 is shown such that the application program is an operating subject differing from the user terminal, but this is shown only for convenience of description of operation flows, and, in practice, the application program is executed on the user terminal.

As described above, the method and apparatus for partially encoding/decoding data for a commitment service and a method of encoded data according to the present invention are advantageous in that the constructions and methods of the above-described embodiments are not limitedly applied, and all or part of the embodiments can be selectively combined with one other to enable various modifications.

According to the present invention, there is an advantage in that table names, field names and field attribute values of a DB are partially encoded while the existing structure of the DB is maintained, and the partially encoded DB is committed to a server, so that even if the user information on the server is leaked, the information is encoded using a private key, thus minimizing damage attributable to such leakage.

Further, there is an advantage in that when a client accesses the DB of a user committed to a server, the client requests the DB from the server by encoding part of a query, thus overcoming the uneasiness of the user even when a commitment service for delicate information is provided.

Furthermore, there is an advantage in that even if queries and resulting responses exchanged between a server and a client are leaked to the other party, it is difficult for the other party to find out the detailed contents of the queries and responses.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method for partially encoding data for a commitment service, comprising:
when a private key is input by a user, transforming the private key;
encoding table names of a database (DB) to be committed to a server using the private key and also encoding field names of each table and fields stored in the table;
transmitting the DB through a trusted channel established between a user terminal and the server to request commitment of the DB to the server; and
deleting the DB committed to the server from the user terminal according to a response signal from the server.

2. The method as set forth in claim 1, wherein the encoding comprises adding a random character string to an attribute value stored in each field of the table, and the attribute value to which the character string is added is encoded.

3. The method as set forth in claim 1, further comprising, before the encoding, copying the DB to be committed to the server to a predetermined area so as to encode the DB.

4. The method as set forth in claim 3, wherein the deleting comprises deleting the DB copied to the predetermined area.

5. The method as set forth in claim 1, further comprising, before the requesting the commitment of the DB, establishing the trusted channel between the user terminal and the server based on authentication information shared therebetween.

6. The method as set forth in claim 1, wherein the transforming the private key is performed using a random permutation function.

7. A method for partially decoding data for a commitment service, comprising:
a user terminal requesting a database (DB) of a user stored in a server to receive the DB from the server;
transforming a private key input by the user so as to decode the DB received from the server;
decoding table names of the received DB using the private key and also decoding field names and fields of each table; and
requesting the server to delete the DB stored in the server.

8. The method as set forth in claim 7, further comprising:
copying the DB at the receiving to a temporary area for decoding; and
after the decoding, storing the DB copied to the temporary area, at a designated location.

9. The method as set forth in claim 7, wherein the transforming the private key is performed using a random permutation function.

10. A method of using encoded data, comprising:
when an application program is executed, generating a Structured Query Language (SQL) query required to perform tasks based on a database (DB) committed to a server;
loading a previously registered private key of a user to encode the SQL query using the private key;
transmitting an encoded SQL query to the server, and receiving an execution result message of the SQL query, generated after execution of the SQL query, from the server; and
decoding the execution result message of the SQL query to apply a decoded execution result message of the SQL query to the application program.

11. The method as set forth in claim 10, wherein the execution result message of the SQL query is configured in an Extensible Markup Language (XML) format by the server.

12. The method as set forth in claim 10, wherein the encoding the SQL query encodes least one of field names, table names, and attribute values of the SQL query, using the private key of the user.

13. The method as set forth in claim 10, wherein the encoding the SQL query encodes the SQL query such that grammar of the SQL query is maintained without change.

14. The method as set forth in claim 10, wherein the applying the decoded execution result message of the SQL query to the application program further comprises generating a data type, which is usable by the application program, using the decoded execution result message of the SQL query, and
wherein the application program is executed using the data type.

15. An apparatus for partially encoding/decoding data for a commitment service, comprising:
a key storage unit for storing a private key of a user;
a key management module for, when the private key is input by the user, transforming the private key to store a transformed private key in the key storage unit, and managing information about the private key; and
an encoding/decoding module for encoding/decoding a database (DB) to be committed to a server using the private key of the user, which has been obtained by accessing the key storage unit through the key management module, and also encoding/decoding a Structured Query Language (SQL) query required to use the DB committed to the server,
wherein the encoding/decoding module partially encodes/decodes at least one of table names, field names, and attribute values of the DB.

16. The apparatus as set forth in claim 15, wherein the encoding/decoding module performs encoding by adding a random character string to a relevant attribute value of the DB when the DB is encoded.

17. The apparatus as set forth in claim 15, wherein the key management module generates a transformed private key of the user whenever a new DB is committed to the server.

18. The apparatus as set forth in claim 15, wherein the key management module is configured such that when a predetermined period of time has elapsed or when a specific condition is satisfied, with respect to the private key of the user stored in the key storage unit, the private key of the user is deleted.

19. The apparatus as set forth in claim 15, wherein the key management module uses a random permutation function when the private key of the user is transformed.

20. The apparatus as set forth in claim 15, further comprising an application execution module for generating the SQL query that allows the application program to perform DB-based tasks and executing the application program using an execution result message of the SQL query received from the server in response to the SQL query.
